(19) United States
(12) Patent Application Publication
(10) Pub. No.: US 2020/0075267 A1
(43) Pub. Date: Mar. 5, 2020

(54) ELECTRICITY STORAGE DEVICE

(71) Applicant: HONDA MOTOR CO., LTD., Tokyo (JP)

(72) Inventors: Hironori Sawamura, Tochigi (JP); Shinya Watanabe, Tochigi (JP); Yasuhisa Saito, Tochigi (JP); Hitoshi Saito, Tochigi (JP); Shinyu Hirayama, Tochigi (JP); Shogo Nagayoshi, Tochigi (JP)

(21) Appl. No.: 16/461,189

(22) PCT Filed: Nov. 20, 2017
(86) PCT No.: PCT/JP2017/041631

§ 371 Date: May 15, 2019

(30) Foreign Application Priority Data
Nov. 25, 2016 (JP) 2016-229158

(51) Int. Cl. H01G 11/18; H01G 11/10; H01G 11/82; H01G 2/04; H01M 10/613; H01M 10/647; H01M 10/653; H01M 10/6555; H01M 10/6557; H01M 10/6568; H01G 11/06

(52) U.S. Cl. CPC H01G 11/18; H01G 11/10; H01G 11/82; H01G 2/04; H01M 10/613; H01G 11/06; H01M 10/653; H01M 10/6555; H01M 10/6557; H01M 10/6568; H01M 10/647

(57) ABSTRACT

An electricity storage device is provided with a heat transfer sheet which is arranged between an electricity storage body and a water jacket and which is capable of being elastically deformed. The water jacket has formed therein a fluid distribution section in communication with a cooling fluid inlet of the water jacket, a fluid recovery section in communication with a cooling fluid outlet of the water jacket, and a heat exchange section which connects the fluid distribution section and the fluid recovery section via a fluid passageway partitioned by fins rising in the thickness direction of the water jacket. The heat transfer sheet is arranged in an area which corresponds to the heat exchange section on the surface of a body section and which does not overlap the fluid distribution section and the fluid recovery section.

### TECHNICAL FIELD

The present invention relates to an electricity storage device including a cooling member which cools an electricity storage body.

### BACKGROUND ART

Conventionally, an electricity storage device which cools electricity storage bodies arranged side by side by way of a cooling member has been known. As documents disclosing this type of electricity storage device, there is Patent Document 1 and Patent Document 2, for example. Patent Document 1 describes a battery heat exchange device having an inflow duct and outflow duct, and having a flat heat exchange section in which the flow of heat transfer medium crosses. Patent Document 2 describes, in regards to an assembled battery made by sandwiching a plurality of battery modules with cooling plates together, the assembled battery including an insulating sheet having thermal conductivity provided between the plate and battery module, and a cooling channel provided within the plate and through which coolant circulating in a coolant circuit having at least a coolant compressor flows.

Patent Document 1: Japanese Unexamined Patent Application (Translation of PCT Application), Publication No. 2016-506030

Patent Document 2: Japanese Unexamined Patent Application, Publication No. 2011-49137

### DISCLOSURE OF THE INVENTION

### Problems to be Solved by the Invention

However, the volume of the electricity storage body may change by expanding from charging/discharging or the like. If the electricity storage body expands and the volume becomes larger, there has been concern over the channel of cooling fluid inside of the cooling member being crushed and decreasing the cooling performance. In this regard, expansion in the volume of the electricity storage body caused by charging/discharging is not considered in the configuration described in Patent Document 1 and Patent Document 2, and there has been a possibility for a decline in cooling performance occurring due to expansion.

The present invention has an object of providing a configuration to an electricity storage device arranging a plurality of electricity storage bodies and cooling members alternately, which can reliably prevent a decline in cooling performance caused by expansion of the electricity storage bodies.

### Means for Solving the Problems

The present invention is related to an electricity storage device (for example, the electricity storage device 1 described later) which cools a plurality of electricity storage bodies (for example, the electricity storage body 21 described later) arranged in line by way of a cooling member (for example, the cooling member 35 described later), the cooling member including: a flat plate part (for example, the water jacket 40 described later) which is disposed alternately with the electricity storage body, and inside which cooling fluid flows; and a heat transfer sheet (for example, the heat transfer sheet 30 described later) which is disposed between the electricity storage body and the flat plate part, and is elastically deformable; in which inside of the flat plate part has formed therein: an inlet-side cavity (for example, the fluid distribution section 70 described later) communicating with an inlet of cooling fluid in the flat plate part, an outlet-side cavity (for example, the fluid recovery section 72 described later) communicating with an outlet of cooling fluid in the flat plate part, and a heat exchange section (for example, the heat exchange section 67 described later) which connects the inlet-side cavity and the outlet-side cavity by way of a fluid passageway (for example, the fluid passageway 71 described later) partitioned by a partition member (for example, the fin 80 described later) which stands up in the thickness direction of the flat plate part between the inlet-side cavity and the outlet-side cavity; in which the heat transfer sheet is disposed in a range corresponding to the heat exchange section of a surface of the flat plate part, which is a range not overlapping with the inlet-side cavity and the outlet-side cavity. Even in a case of the electricity storage body swelling by charging/discharging, it is thereby possible to absorb the displacement amount thereof by the elastic deformation of the heat transfer sheet fixed to the range of the heat exchange section. Even in the case of the displacement amount in the volume of the electricity storage body being large, since the rigidity of the heat exchange section increases by the partition members standing in the thickness direction, the fluid passageway will not be collapsed from the pressing force of the electricity storage body. In addition, since it becomes a configuration in which there is no heat transfer sheet in the range corresponding to the inlet-side cavity and outlet-side cavity, the expansion space of the electricity storage body is secured, and the inlet-side cavity and outlet-side cavity will not be pressed against the electricity storage body via the heat transfer sheet. In this way, it is a configuration in which the passageway in which cooling fluid flows in the flat plate part is protected, even if swelling of the electricity storage body occurs. Furthermore, generally, in an electricity storage body such as a lithium-ion capacitor, since the heat generating element on the inside will not be at the outer circumference, it is possible to efficiently cool more than arranging the heat transfer sheet on the entire surface of the water jacket (flat plate part).

It is preferable for the heat exchange section to be a structure in which a plurality of notch parts extending along a flow direction of the cooling fluid to be formed in an inner surface of the flat plate part in a direction orthogonal to the flow direction of the cooling fluid as the partition member, and in which the notch part stands in relation to the inner surface. Since the flat plate part is thereby supported from the inside by the plurality of notch parts standing up from the inside surface, it is possible to effectively raise the rigidity relative to pressing force, and possible to more reliably protect the fluid passageway forming the heat exchange section.

It is preferable to further include: an inlet-side connection member (for example, the in-side connection pipe 60a and in-side joint part 61a described later) which connects an inlet of each of the flat plate parts disposed on both sides of the electricity storage body; and an outlet-side connection member (for example, the out-side connection pipe 60b and out-side joint part 61b described later) which connects an outlet of each of the flat plate parts disposed on both sides of the electricity storage body. It is thereby possible to realize supply of cooling fluid to each flat plate part and recovery with a simple configuration.

### Effects of the Invention

According to the electricity storage device of the present invention, it is possible to reliably prevent a decline in cooling performance caused by expansion of the electricity storage bodies.

### BRIEF DESCRIPTION OF THE DRAWINGS

FIG. 1 is a perspective view showing an electricity storage device according to an embodiment of the present invention;

FIG. 2 is an exploded perspective view of an electricity storage device according to the present embodiment;

FIG. 3 is an exploded perspective view of an electric path body of the present embodiment;

FIG. 4 is a perspective view of an electricity storage body inserted in a water jacket constituting an LiC/WJ stack of the present embodiment;

FIG. 5 is an exploded perspective view of a part of each member constituting the LiC/WJ stack of the present embodiment;

FIG. 6 is an exploded perspective view of a water jacket of the present embodiment;

FIG. 7 is an expanded perspective view showing fins of a water jacket of the present embodiment;

FIG. 8 is a perspective view schematically showing the flow of cooling fluid inside the water jacket of the present embodiment;

FIG. 9 is a perspective view schematically showing the flow of cooling fluid of the LiC/WJ stack of the present embodiment; and

FIG. 10 is a perspective view schematically showing the flow of cooling fluid in a LiC/WJ stack of a modified example.

### PREFERRED MODE FOR CARRYING OUT THE INVENTION

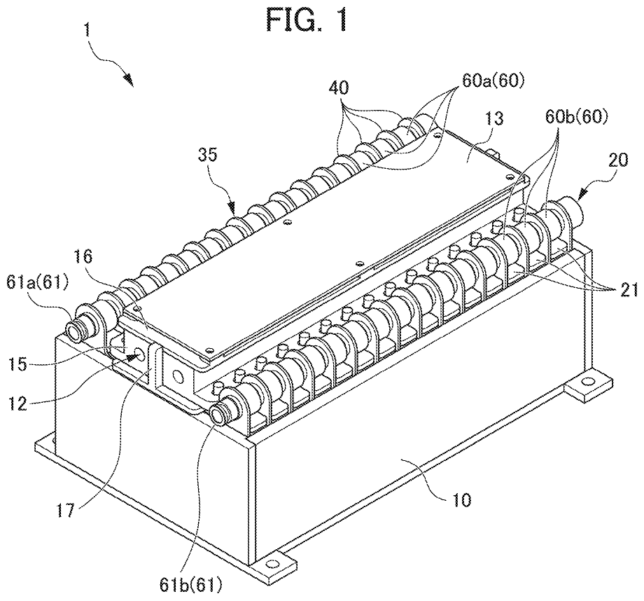

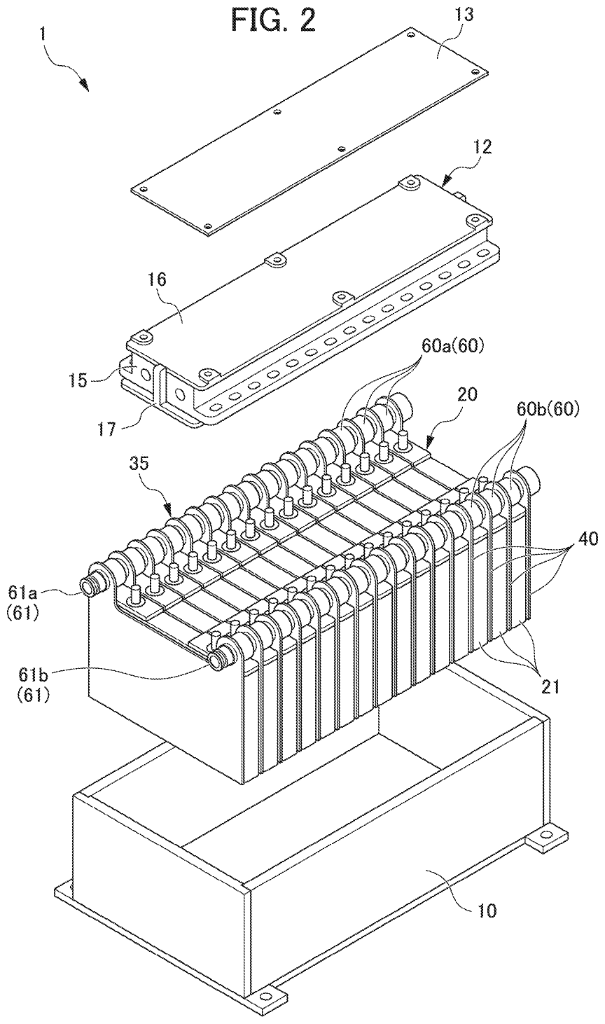

Hereinafter, a preferred embodiment of the present invention will be explained by referencing the drawings. FIG. 1 is a perspective view showing an electricity storage device 1 according to an embodiment of the present invention. FIG. 2 is an exploded perspective view of the electricity storage device 1 of the present embodiment. It should be noted that, although explained by illustrating up/down directions and left/right directions for convenience in the following explanation, the orientation of the electricity storage device 1 of the present embodiment is not to be limited to the orientation of up/down/left/right described later.

As shown in FIG. 1 and FIG. 2, the electricity storage device 1 of the present embodiment includes a housing 10, LiC/WJ stack 20, electric path body 12, control substrate 13, and cooling member 35 as main configurations.

The housing 10 is configured to be able to house the LiC/WJ stack 20 on the inside thereof. The electric path body 12 is arranged above the LiC/WJ stack 20. The control substrate 13 is arranged above the electric path body 12.

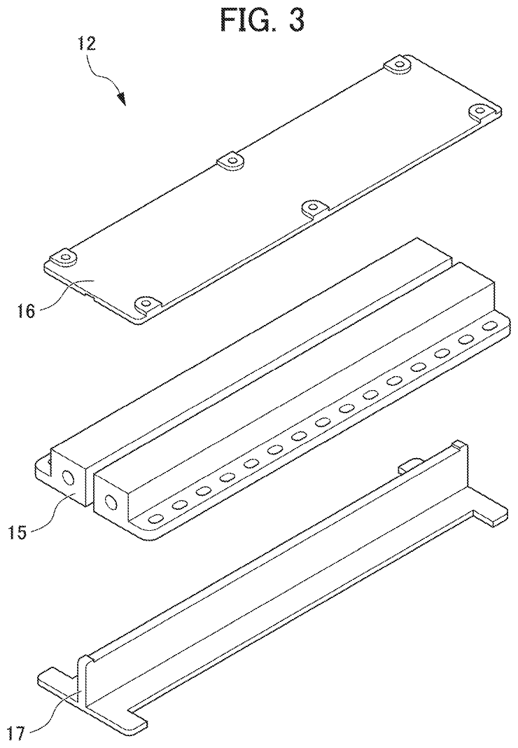

FIG. 3 is an exploded perspective view of the electric path body 12 of the present embodiment. As shown in FIG. 3, the electric path body 12 includes an electrical circuit 15, a substrate support body 16 arranged above the electrical circuit 15, and an inverted T-shaped insulator 17 arranged below the electrical circuit 15.

The LiC/WJ stack 20 is a laminate of LiC (lithium-ion capacitor) consisting of a plurality of electricity storage bodies 21 arranged in parallel in a predetermined direction. Regarding the electricity storage body 21, the shape thereof assumes a cuboid shape (tabular shape) that is long sideways, and a planar portion thereof faces the arranged direction of the electricity storage bodies 21. In the following explanation, the direction in which the electricity storage bodies 21 are arranged may be explained as the stack direction. The plurality of electricity storage bodies 21 arranged in the stack direction is cooled by the cooling member 35.

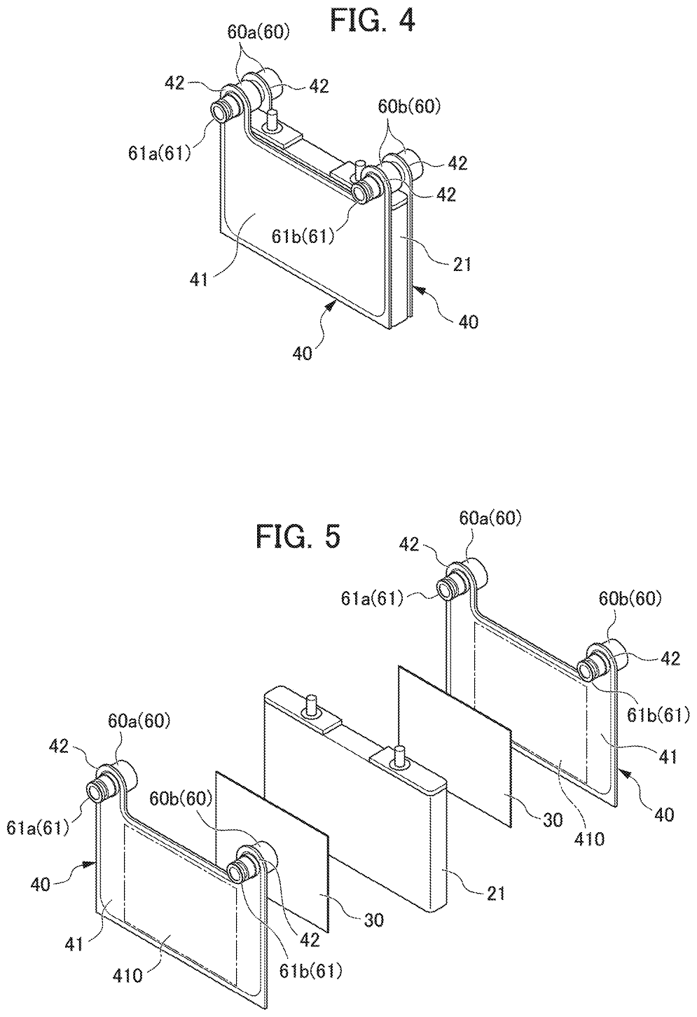

FIG. 4 is a perspective view of the electricity storage body 21 fitted in the water jacket 40 constituting the LiC/WJ stack 20 of the present embodiment. FIG. 5 is an exploded perspective view showing a part of each member constituting the LiC/WJ stack 20 of the present embodiment.

As shown in FIG. 4 and FIG. 5, the cooling member 35 of the present embodiment includes a flat water jacket (flat plate part) 40, and a thermally conductive sheet (heat transfer sheet) 30. Each member constituting the LiC/WJ stack 20 including the cooling member 35 is repeatedly arranged in the order of water jacket 40, heat transfer sheet 30, electricity storage body 21, heat transfer sheet 30, water jacket 40, . . . .

The heat transfer sheet 30 is arranged on both sides in the stack direction of the electricity storage body 21, respectively, and the heat of the electricity storage body 21 is transferred to the water jacket 40 via the heat transfer sheet 30.

The heat transfer sheet 30 is configured by a material having thermal conductivity, for example, silicone. The heat transfer sheet 30 has thickness, and is configured to be elastically deformable in the thickness direction thereof. The heat transfer sheet 30 of the present embodiment is arranged at a heat exchange surface 410, which is the surface of the water jacket 40. The heat exchange surface 410 is a range corresponding to the range of the heat exchange section 67 described later on the inside of the water jacket 40 described later.

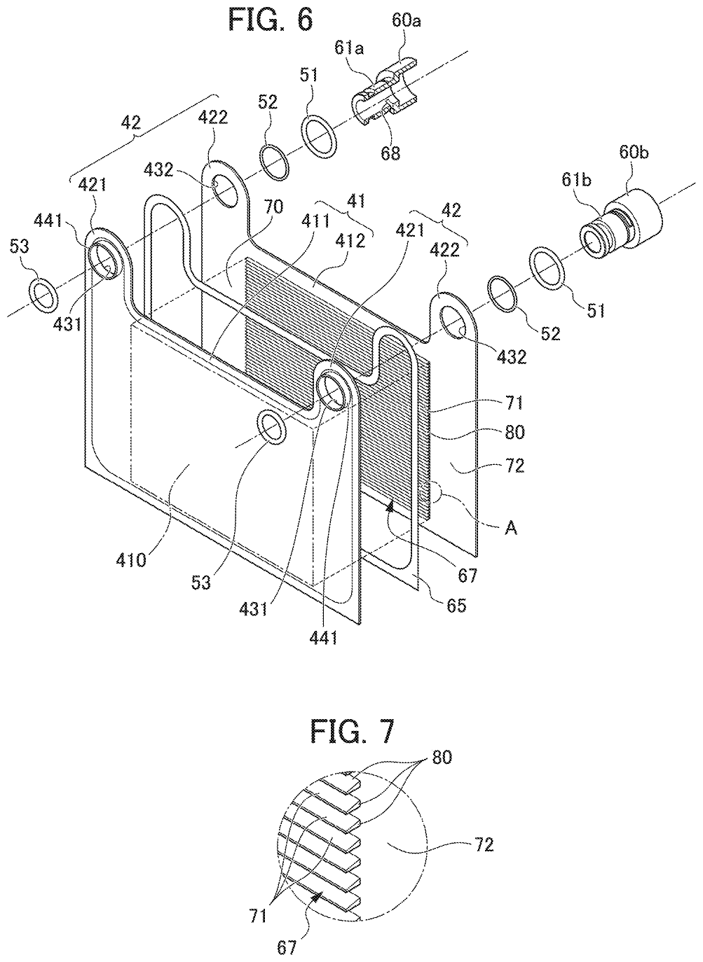

The water jacket 40 will be explained. FIG. 6 is an exploded perspective view of the water jacket 40 of the present embodiment. FIG. 7 is an expanded perspective view showing fins 80 of the water jacket 40 of the present embodiment, in which a region A in FIG. 6 is enlarged.

The water jacket 40 of the present embodiment includes a main body part 41 and extension parts 42 arranged at both ends of a top of the main body part 41, respectively.

As shown in FIG. 6, the main body part 41 of the water jacket 40 is configured by the two plate members of a first plate member 411 and second plate member 412 overlapping in the stack direction. The first plate member 411 has a first extension piece 421 extending upwards which is arranged at each of both left/right sides at the top part thereof. In addition, the second plate member 412 has a second extension piece 422 extending upwards, which is arranged at each of both left/right sides at the top part thereof.

The first plate member 411 and second plate member 412 are coupled in the stack direction via a silver brazing frame member 65. The silver brazing frame member 65 is formed in a frame shape according to the external form of the first plate member 411 and second plate member 412, and the heat exchange section 67 described later fits inside.

A joint part 61 is arranged at one side in the stack direction of the extension part 42, and a connection pipe 60 is arranged at the other side thereof. The joint part 61 and connection pipe 60 of the present embodiment are both cylindrical members, and are integral members at which the spaces on the inside are in communication with each other. In addition, the joint part 61 is configured to be able to fit inside of the connection pipe 60 of the water jacket 40 adjoining in the stack direction.

In the joint part 61, an opening section 68 which connects the space on the inside thereof and the inside of the water joint 40 is formed. The opening section 68 is formed at a position and shape capable of communicating the inside of the joint part 61 and interior of the water jacket 40, in a state in which the joint part 61 fits with the adjacent connection pipe 60.

A first through hole 431 is formed in the first extension piece 421, and a second through hole 432 is formed in the second extension piece 422. The joint part 61 is fixed in a state passing through the first through hole 431 and second through hole 432. In the present embodiment, a cylindrical part 441 is formed in a surface on the opposite side to a side of the first extension piece 421 which opposes the second extension piece 422, and the joint part 61 is fixed in a state having a leading end projecting from the inner side of this cylindrical part 441. Then, the joint part 61 projecting from the cylindrical part 441 of the extension part 42 is coupled to the connection pipe 60 of the adjoining water jacket 40 via an O-ring 53. The connection pipe 60, which is positioned on the opposite side of the joint part 61, is positioned on the second extension piece 422 side, in a state in which the joint part 61 passes through the first through hole 431 and second through hole 432. A first silver brazing ring 51 and second silver brazing ring 52 are arranged between the connection pipe 60 and second plate member 412. It should be noted that, in the present example, although the cylindrical part 441 is provided integrally by the first and second extension parts 421, 422, the connection pipe 60 may be fixed by providing a separate annular member. In addition, in the present example, the opening section 68 of the connection pipe 60 is made a shape cutting in the short-diameter cross section; however, it may be configured to provide a plurality of holes in the normal line direction of the connection pipe 60.

The silver braze arranged on each part of the water jacket 40 (silver brazing frame member 65, first silver brazing ring 51, second silver brazing ring 52) is used in welding, and is used in joint fixation of the first plate member 411 and second plate member 412, and/or joint fixation of the connection pipe 60 and joint part 61. In the water jackets 40 aligned in the stack direction, the cooling fluid circulates through the connection pipe 60 and joint part 61.

Next, the flow of cooling fluid inside of the water jacket 40 will be explained. A fluid channel 71 of the cooling fluid corresponding to the position of the heat exchange surface 410 is formed at the surface of the second plate member 412 opposing the first plate member 411. As shown in FIG. 7, the fluid channel 71 is configured by a plurality of fins (partition member, slit part) 80 extending in the left/right direction, and a portion in which this fluid channel 71 is formed serves as a heat exchange section 67. The fin 80 is a notch shape, and is a posture standing (standing up) from an inside surface of the water jacket 40.

The plurality of fins 80 is aligned in the vertical direction, and is configured so that the cooling fluid flows in the left/right direction between a fin 80 and another fin 80. The fins 80 serve as partition members forming the fluid channel 71. In the present embodiment, after making a notch by machining, the fins 80 are formed so as to cause this notch.

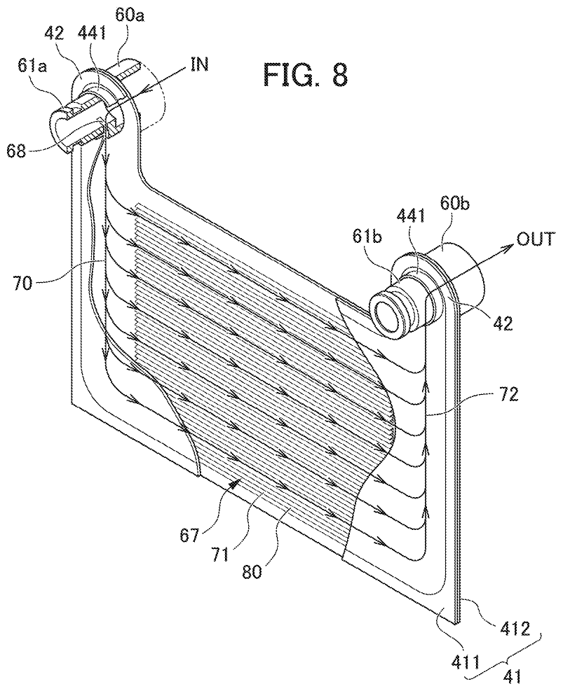

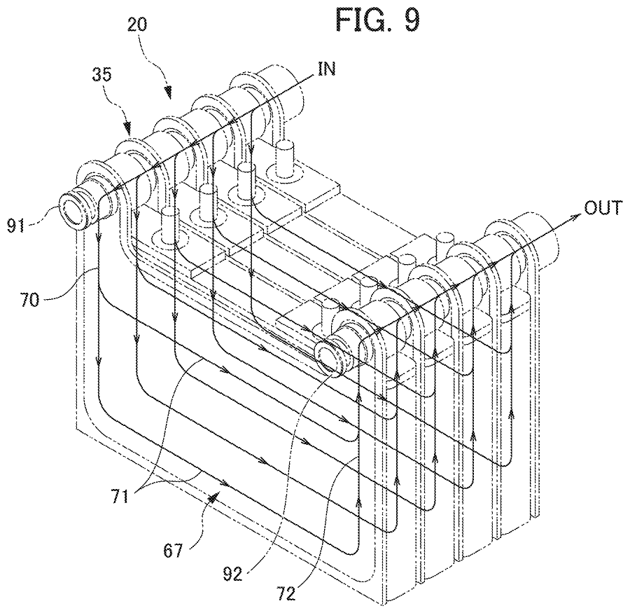

FIG. 8 is a perspective view schematically showing the flow of cooling fluid inside of the water jacket 40 of the present embodiment. FIG. 9 is a perspective view schematically showing the flow of cooling fluid in the LiC/WJ stack 20 of the present embodiment. It should be noted that the flow of cooling medium is indicated by arrows in FIGS. 8 and 9.

The cooling fluid flowing through the inside of the water jacket 40 is sent to each water jacket 40 by the connection tube 60 and joint part 61 serving as connection members to be collected. More specifically, it passes through the opening section 68 of the joint part 61 arranged to penetrate through the extension part 42, and goes in and out from the extension part 42 to inside of the main body 41.

In the present embodiment, the opening section 68 of the join part 61 on one side in the left/right direction becomes the inlet of cooling fluid flowing into the main body 41, and the opening section 68 of the joint part 61 on the other side in the left/right direction becomes the outlet of cooling fluid flowing out from the main body 41. In the following explanation, the connection pipe 60 arranged to the extension part 42 on one side in the left/right side is defined as an in-side connection pipe 60a, and a connection pipe 60 arranged in the extension part 42 on the other side in the left/right direction is defined as an out-side connection pipe 60b. The joint part 61 arranged in the extension part 42 on one side in the left/right direction is defined as an in-side joint part 61a, and a joint part arranged in the extension part 42 on the other side in the left/right direction is defined as an out-side joint part 61b.

A fluid distribution section 70 is connected inside of the water jacket 40 on the upstream side of the fluid passageway 71, and a fluid recovery section 72 is connected to the downstream side of the fluid passageway 71.

The fluid distribution section 70 is an inlet-side cavity formed as a space communicating with the inlet of the cooling fluid inside of the water jacket 40. The fluid distribution section 70 of the present embodiment is arranged on one side in the left/right direction of the fluid passageway 71 inside of the water jacket 40, and is adjacent to the beginning part of the fin 80. The fluid passageway 71 is communicating with the opening section 68 of the in-side joint part 61a via the fluid distribution section 70. The cooling fluid entering inside of the water jacket 40 from the in-side joint part 61a is distributed to a plurality of passageways configured by the fins 80 aligned in the vertical direction in the fluid distribution section 70, and flows from the side of the fluid distribution section 70 to the side of the fluid recovery section 72.

The electricity storage body 21 is cooled by the cooling fluid supplied to the fluid passageway 71 through the fluid distribution section 70 performing heat exchange. In the present embodiment, the range of the fluid passageway 71 configured by the fins 80 becomes the heat-exchange surface 410 performing heat exchange. As shown in FIG. 5, the heat transfer sheet 30 of a size corresponding to the range of the heat exchange surface 410 is arranged between the electricity storage body 21 and water jacket 40, and the electricity storage body 21 is cooled via this heat transfer sheet 30. In addition, the heat transfer sheet 30 is a size which does not overlap with the fluid distribution section 70 and fluid recovery section 72 in the stack direction.

The fluid recovery section 72 is an outlet-side cavity formed as a space communicating with the outlet of the cooling fluid inside of the water jacket 40. The fluid recovery section 72 of the present embodiment is arranged on the other side in the left/right direction of the fluid passageway 71 inside of the water jacket 40 relative to the fluid distribution section 70, and is adjacent to the trailing end of the fin 80. The opening section 68 of the out-side joint part 61b is communicating with the fluid passageway 71 via this fluid recovery section 72. The fluid having flowed from the upstream side between the plurality of fins 80 (fluid passageway 71) merges at the fluid recovery section 72 and flows to outside of the water jacket 40 from the out-side joint part 61b. The cooling fluid for which the temperature has risen by way of heat exchange while passing through the fluid passageway 71 is thereby discharged to outside of the water jacket 40.

In the example shown in FIG. 9, a stopper (omitted from drawings) is arranged to prevent discharge to outside of the cooling fluid to the outlet 91 of the in-side joint part 61a of the water jacket 40 at the forward most side to which the cooling fluid is ultimately supplied. In addition, a stopper (omitted from drawings) is arranged to prevent discharge to outside of cooling fluid also to the outlet 92 of the out-side connection pipe 60b of the water jacket 40 at the forward-most side.

By the cooling fluid flowing to one side in the stack direction from the upstream side (IN side in FIG. 9) connected to the supply source of cooling fluid, the cooling fluid is respectively supplied to the fluid distribution section 70 of each water jacket 40 aligned in the stack direction. The cooling fluid carrying out heat exchange at the fluid passageway 71 inside of the water jacket 40 is sent from the fluid recovery section 72 through the out-side connection pipe 60b and out-side joint part 61b to the downstream side (OUT side in FIG. 9).

In the present embodiment, the heat transfer sheet 30 is arranged in the range of the heat exchange surface 410, and the heat exchange between the water jacket 40 and electricity storage body 21 is carried out via the heat transfer sheet 30. It should be noted that, on both sides of the heat exchange surface 410 of the water jacket 40, the heat transfer sheet 30 is not arranged in the range overlapping the fluid distribution section 70 and fluid recovery section 72 in the stack direction. Therefore, in the range corresponding to the fluid distribution section 70 and fluid recovery section 72 of the water jacket 40, a gap according to the thickness of the heat transfer sheet 30 is formed between the electricity storage bodies 21. In addition, since the electricity storage body 21 and water jacket 40 are alternately arranged in the stack direction, the heat transfer sheet 30 is arranged on both sides of the water jacket 40.

According to the above-explained embodiment, the following such effects are exerted. The cooling member 35 equipped to the electricity storage device 1 includes the water jacket 40 arranged alternately with the electricity storage body 21, and through which cooling fluid flows inside, and the heat transfer sheet 30 which is arranged between the electricity storage body 21 and water jacket 40, and is elastically deformable. Inside of the water jacket 40 is formed the fluid distribution section 70 communicating with the inlet of cooling fluid of the water jacket 40, the fluid recovery section 72 communicating with the outlet of cooling fluid in the water jacket 40, and the heat exchange section 67 which connects the fluid distribution section 70 and fluid recovery section 72 by the fluid passageway 71 divided by the fins 80 standing in the thickness direction of the water jacket 40 between the fluid distribution section 70 and fluid recovery section 72. The heat transfer sheet 30 is arranged (pasted) in a range corresponding to the heat exchange section 67 on the surface of the main body 41, which is a range not overlapping with the fluid distribution section 70 and fluid recovery section 72.

Even in a case of the electricity storage body 21 swelling by charging/discharging, it is thereby possible to absorb the displacement amount thereof by the elastic deformation of the heat transfer sheet 30 fixed to the heat exchange surface 410, which is a region of the heat exchange section 67. Even in the case of the displacement amount in the volume of the electricity storage body being large, since the rigidity of the heat exchange section 67 increases by the fins 80 standing in the thickness direction, the fluid passageway 71 will not be collapsed from the pressing force of the electricity storage body 21. In addition, since it becomes a configuration in which there is no heat transfer sheet 30 in the range corresponding to the fluid distribution section 70 and fluid recovery section 72, the expansion space of the electricity storage body 21 is secured, and a gap in the stack direction is formed between the electricity storage bodies 21 in a range of the water jacket 40 corresponding to the fluid distribution section 70 and fluid recovery section 72. The fluid distribution section 70 and fluid recovery section 72 are thereby no longer pressed by the electricity storage body 21 via the heat transfer sheet 30, and it is possible to effectively avoid the occurrence of a situation in which the fluid distribution section 70 and fluid recovery section 72 are crushed. In this way, it will be a configuration in which the passageway inside of the water jacket 40 is protected, even if swelling of the electricity storage body 21 occurs. Furthermore, generally, in an electricity storage body such as a lithium-ion capacitor, since the heat generating element on the inside will not be at the outer circumference, it is possible to efficiently cool more than arranging the heat transfer sheet 30 on the entire surface of the water jacket 40.

In addition, the heat exchange section 67 of the present embodiment is a structure in which a plurality of the fins 80 extending along the flow direction of cooling fluid flowing is formed at the inside surface of the water jacket 40 at intervals in a direction orthogonal to the flow direction of the cooling fluid as a partition member, and these fins 80 stand up relative to the inside surface.

Since the water jacket 40 is thereby supported from the inside by the plurality of fins 80 standing up from the inside surface, it is possible to effectively raise the rigidity relative to pressing force, and possible to more reliably protect the fluid passageway 71 forming the heat exchange section 67.

In addition, the electricity storage device 1 of the present embodiment further includes: the in-side connection pipe 60a and in-side joint part 61a connecting the inlet of cooling fluid in each of the water jackets 40 arranged on both sides of the electricity storage body 21; and the out-side connection pipe 60b and out-side joint part 61b connecting the outlet of each of the water jackets 40 arranged on both sides of the electricity storage body 21.

It is thereby possible to realize supply of cooling medium to each water jacket 40 and recovery by a simply configuration.

Although a preferred embodiment of the present invention has been explained above, the present invention is not to be limited to the aforementioned embodiment, and appropriate modifications are possible.

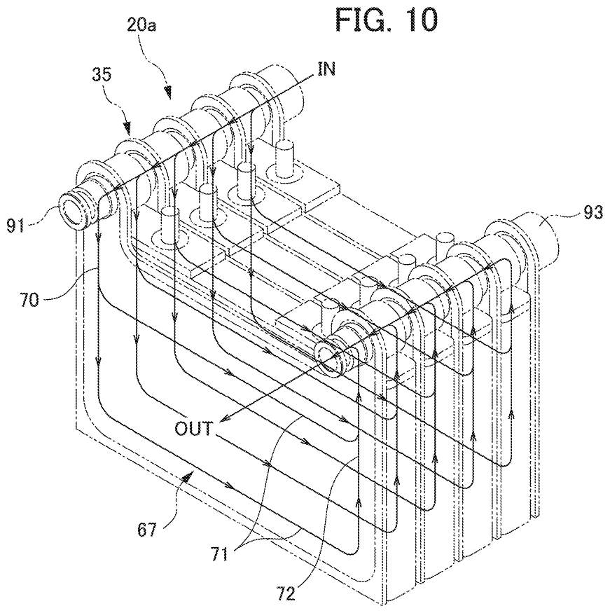

For example, the direction in which cooling fluid flows can be modified as appropriate. Furthermore, a modified example showing an example of the flow direction of cooling fluid differing will be explained. FIG. 10 is a perspective view schematically showing the flow of cooling fluid in the LiC/WJ stack 20a of the modified example. In the example shown in FIG. 10, a stopper (omitted from drawings) to prevent discharge to outside of cooling fluid is arranged at the outlet 91 of the in-side joint part 61a of the water jacket 40 that is the forward-most side to which cooling fluid is ultimately supplied, and a stopper (omitted from drawings) to prevent discharge to outside of cooling fluid is also provided to the outlet 93 of the out-side connection pipe 60b of the water jacket 40 that is the rear-most side. In the case of the modified example shown in FIG. 10, the direction in which the cooling fluid flows through the in-side connection pipe 60a and in-side joint part 61a, and the direction in which the cooling fluid flows through the out-side connection pipe 60b and out-side joint part 61b become the same direction. Also in this modified example, it is possible to supply cooling fluid to each water jacket 40 and recover. In addition, the electricity storage body 21 is not limited to the lithium-ion capacitor, and it is possible to apply to an electricity storage body which undergoes heat generation and expansion including a lithium-ion battery. Furthermore, the fins 80 can be manufactured by a common metal forming method such as casting, and the shape is not limited to the present example.

### EXPLANATION OF REFERENCE NUMERALS

1 electricity storage device
21 electricity storage body
30 thermally conductive sheet (heat transfer sheet)
40 water jacket (flat plate part)
60a in-side connection pipe (connection member)
60b out-side connection pipe (connection member)
61a in-side joint part (connection member)
61b out-side joint part (connection member)
67 heat exchange section
70 fluid distribution section (inlet-side cavity)
71 fluid passageway
72 fluid recovery section (outlet-side cavity)
80 fin (partition member, notch part)

1. An electricity storage device which cools a plurality of electricity storage bodies arranged in line by way of a cooling member,
wherein the cooling member comprises:
a flat plate part which is disposed alternately with the electricity storage body, and inside which cooling fluid flows; and
a heat transfer sheet which is disposed between the electricity storage body and the flat plate part, and is elastically deformable,
wherein inside of the flat plate part has formed therein:
an inlet-side cavity communicating with an inlet of cooling fluid in the flat plate part,
an outlet-side cavity communicating with an outlet of cooling fluid in the flat plate part, and
a heat exchange section which connects the inlet-side cavity and the outlet-side cavity by way of a fluid passageway partitioned by a partition member which stands up in the thickness direction of the flat plate part between the inlet-side cavity and the outlet-side cavity,
wherein the heat transfer sheet is disposed in a range corresponding to the heat exchange section of a surface of the flat plate part, which is a range not overlapping with the inlet-side cavity and the outlet-side cavity.

2. The electricity storage device according to claim 1,
wherein the heat exchange section is a structure in which a plurality of notch parts extending along a flow direction of the cooling fluid is formed in an inner surface of the flat plate part in a direction orthogonal to the flow direction of the cooling fluid as the partition member, and
in which the notch part stands in relation to the inner surface.

3. The electricity storage device according to claim 1, further comprising:
an inlet-side connection member which connects an inlet of each of the flat plate parts disposed on both sides of the electricity storage body; and
an outlet-side connection member which connects an outlet of each of the flat plate parts disposed on both sides of the electricity storage body.

4. The electricity storage device according to claim 2, further comprising:
an inlet-side connection member which connects an inlet of each of the flat plate parts disposed on both sides of the electricity storage body; and
an outlet-side connection member which connects an outlet of each of the flat plate parts disposed on both sides of the electricity storage body.
